(19) United States
(12) Patent Application Publication
(10) Pub. No.: US 2026/0135827 A1
(43) Pub. Date: May 14, 2026

(54) METHOD AND DEVICE FOR PROVIDING POSITION-BASED CHAT ROOM ENTRY FUNCTION

(71) Applicant: KAKAO CORP., Jeju-si (KR)

(72) Inventors: SUNJOO OH, Seongnam-si (KR); DO YI KIM, Seongnam-si (KR); HYEONWOO KIM, Seongnam-si (KR); SEONGJU WOO, Seongnam-si (KR); HYEON MO JEONG, Seongnam-si (KR); SOO BUM KIM, Seongnam-si (KR); SUWOONG BYUN, Seongnam-si (KR); HYUK JO, Seongnam-si (KR); MI JIN LEE, Seongnam-si (KR); Ju Ho CHUNG, Seongnam-si (KR); SUNWOO KIM, Seongnam-si (KR); KWANGHOON CHOI, Seongnam-si (KR); JISU LEE, Seongnam-si (KR); JUNYOUNG KIM, Seongnam-si (KR); EON JU PARK, Seongnam-si (KR); SEOLMIN PARK, Seongnam-si (KR); YOONA HEO, Seongnam-si (KR); TAEMI KIM, Seongnam-si (KR)

(73) Assignee: KAKAO CORP., Jeju-si (KR)

(21) Appl. No.: 19/379,236

(22) Filed: Nov. 4, 2025

(30) Foreign Application Priority Data
Nov. 8, 2024 (KR) 10-2024-0158322

(51) Int. Cl. H04L 51/04; H04L 9/08

(52) U.S. Cl. CPC H04L 51/04; H04L 9/0825

(57) ABSTRACT

A server includes at least one processor including processing circuitry, and a memory including one or more storage media storing instructions, wherein the instructions, when executed individually or collectively by the at least one processor, cause the server to provide a position-based chat room entry function. In response to an activation request from a host terminal of the chat room, the server determines a join area based on the position of the host terminal, generates a join code corresponding to the chat room, and transmits information about the generated join code to the host terminal. The server then activates the position-based chat room entry function based on the join code and the join area, allowing guest terminals located within the join area and providing the join code to join the chat room. This enables location-dependent participation while maintaining controlled and secure access through coordinated server processing and temporary join credentials.

### CROSS-REFERENCE TO RELATED APPLICATIONS

This application claims the benefit under 35 USC § 119(a) of Korean Patent Application No. 10-2024-0158322, filed on Nov. 8, 2024, in the Korean Intellectual Property Office, the entire disclosure of which is incorporated herein by reference for all purposes.

### BACKGROUND

### Technical Field

Hereinafter, a method of providing a position-based chat room entry function in an instant messaging service is provided.

### Description of Related Art

Recently, with the development of mobile smart devices, the use of an online platform service to communicate with other users via a network has increased. The online platform service for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. As the interaction among users via mobile devices increases, the online platform services provide various service functions based on communication among users in addition to a chat service for conversations with other users.

Conventional instant messaging systems rely on static invitation links or manual friend approvals to control chat room entry (e.g., control access to chat rooms). These methods require repeated user input and impose server-side verification delays, particularly in mobile contexts where user positions are constantly changing. These conventional systems treat the joining process as a social or administrative function rather than a computational one, resulting in delays, redundant communication steps, and potential security vulnerabilities. Further, existing systems lack mechanisms to automatically authenticate proximity-based users and to manage secure session entry using real-time sensor data. As a result, connection latency, user authentication complexity, and communication security degradation occur in dynamic mobile environments.

The present disclosure instead addresses a network control and device coordination problem, in which server and terminal devices cooperate to determine access permissions automatically based on verified positional information and activation parameters.

### BRIEF SUMMARY

The present disclosure provides a position based chat room entry system that enables users to join instant messaging chat rooms automatically according to their physical location and a temporary join code. When a host activates the function, the server defines a geographic join area around the host device and issues a join code. Guests located within that area who input the correct code may join the chat room directly without the need for approval from the host. This arrangement simplifies real world group participation by allowing immediate access based on proximity while maintaining user control through limited activation time and code validity.

The system further includes dynamic and cooperative join area management, allowing multiple host or participant devices to define overlapping or expanded zones that may be updated automatically as the hosts move. The join area can be reactivated during later sessions and may be determined using various proximity methods such as global positioning, Bluetooth, near field communication, or ultrasound. Guests can join without pre existing friend relationships, which is particularly useful for temporary gatherings or meetings.

An important technical aspect of the disclosure is the secure exchange of encrypted information associated with the join code. The private information for the chat room is encrypted using the join code and is transmitted to the guest after successful verification of proximity, allowing secure message access without exposing sensitive data to the server. This combination of location based access control, temporary join codes, and end to end encryption provides a seamless and secure method for spontaneous communication among nearby users.

An instant messaging method performed by a server, includes, in response to an activation request to activate a position-based chat room entry function in a chat room received from a host terminal of the chat room, determining a join area based on a position of the host terminal, in response to the activation request, generating a join code for the chat room and transmitting information about the generated join code to the host terminal, activating the position-based chat room entry function of the chat room based on the join code and the join area, receiving a join request with respect to the chat room from a guest terminal of a guest account, determining whether the join request is generated via an access link to the chat room or via the position-based chat room entry function, based on that the join request is generated via the access link to the chat room, determining whether to add the guest account to a participant of the chat room according to a response from the host terminal to the join request, and based on that the join request is generated via the position-based chat room entry function, adding the guest account to a participant of the chat room independently of a response from the host terminal.

The method further includes receiving, from the guest account, information about an input code input by a user, from a plurality of candidate chat rooms with activated position-based chat room entry functions, determining the chat room having the join code that is the same as the input code, based on that the guest terminal is positioned in a join area of the determined chat room, allowing the guest account to join the chat room and transmitting information about the determined chat room to the guest terminal, and based on receiving a join request to join the chat room from the guest terminal, adding the guest account to a participant of the chat room.

The determining of the join area includes, based on that the host terminal of the chat room includes a first host terminal and a second host terminal, determining a second area determined based on a position of the second host terminal to be the join area together with a first area determined based on a position of the first host terminal.

The determining of the join area includes, based on receiving, from the host terminal, an addition request of a join area based on another user account that joins the chat room, adding an area determined based on a position of the other user account to the join area.

The determining of the join area includes, in response to a first activation request received from the host terminal, determining a first join area based on a first position of the host terminal at a first time point corresponding to the first activation request, wherein the method further includes based on at least one of a deactivation request to deactivate the position-based chat room entry function received from the host terminal or elapse of a predetermined time from the first time point, deactivating the position-based chat room entry function of the chat room based on the first activation request, based on receiving a second activation request with respect to the chat room from the host terminal after deactivation, determining a second join area based on a second position of the host terminal at a second time point corresponding to the second activation request, and activating the position-based chat room entry function of the chat room to allow a guest account of a guest terminal positioned in at least one of the first join area or the second join area to enter the chat room.

The method further includes, while an entry function to the chat room is activated, based on detecting a position change of the host terminal, changing the join area based on a changed position of the host terminal.

The method further includes receiving ciphertext of a private key of the chat room from the host terminal, wherein the ciphertext is obtained by encrypting a private key of the chat room with the join code, and based on allowing a guest account to join the chat room and receiving a join request to join the chat room from a guest terminal of the guest account, transmitting the ciphertext of the private key of the chat room to the guest terminal, wherein the private key of the chat room is a key of the chat room generated as a pair with a public key of the chat room, and is a decryption key of a message key encrypted with the public key of the chat room, and a message transmitted via the chat room is obtained based on the message key.

An instant messaging method performed by a host terminal of a host account of a chat room, includes transmitting, to a server, an activation request to activate a position-based chat room entry function in the chat room based on a user input, receiving information about a join code for the chat room from the server, and based on that a guest account using a guest terminal joins the chat room via a join request, displaying a screen related to the chat room in which the guest account is added as a participant of the chat room, wherein, when the join request is generated via an access link to the chat room, the guest account joins the chat room according to a response from the host terminal to the join request, and when the join request is generated via the position-based chat room entry function, independently of a response from the host terminal, the guest account joins the chat room based on that the guest terminal obtains an input code that is the same as the join code and the guest terminal is positioned in a join area of the chat room determined based on a position of the host terminal.

The host terminal includes a first host terminal, and based on that the host terminal of the chat room includes the first host terminal and a second host terminal, the join area is determined to be a second area based on a position of the second host terminal together with a first area determined based on a position of the first host terminal.

The method further includes transmitting an addition request of a join area based on another user account that joins the chat room to the server, wherein the join area is changed by adding an area determined based on a position of a terminal of the other user account to the join area.

The transmitting of the activation request to the server includes transmitting a first activation request to the server at a first time point, the join area includes a first join area determined based on a first position of the host terminal at the first time point, the position-based chat room entry function based on the first activation request is deactivated based on at least one of transmitting a deactivation request to deactivate the position-based chat room entry function to the server or elapse of a predetermined time from the first time point, the method further includes transmitting a second activation request with respect to the chat room to the server at a second time point after deactivation, and the position-based chat room entry function of the chat room based on the second activation request allows a guest account of a guest terminal positioned in at least one of the first join area or a second join area determined based on a second position of the host terminal at the second time point to enter the chat room.

The method further includes, after receiving the information about the join code, generating ciphertext of a private key of the chat room by encrypting the private key of the chat room with the join code, and transmitting the ciphertext of the private key of the chat room to the server, wherein the private key of the chat room is a key of the chat room generated as a pair with a public key of the chat room, and is a decryption key of a message key encrypted with the public key of the chat room, and a message transmitted via the chat room is obtained based on the message key.

A server includes at least one processor including processing circuitry, and memory including one or more storage media storing instructions, wherein the instructions, when executed individually or collectively by the at least one processor, cause the server to, in response to an activation request to activate a position-based chat room entry function in a chat room received from a host terminal of the chat room, determine a join area based on a position of the host terminal, in response to the activation request, generate a join code for the chat room and transmit information about the generated join code to the host terminal, activate the position-based chat room entry function of the chat room based on the join code and the join area, receive a join request with respect to the chat room from a guest terminal of a guest account, determine whether the join request is generated via an access link to the chat room or via the position-based chat room entry function, based on that the join request is generated via the access link to the chat room, determine whether to add the guest account to a participant of the chat room according to a response from the host terminal to the join request, and based on that the join request is generated via the position-based chat room entry function, add the guest account to a participant of the chat room independently of a response from the host terminal.

The instructions, when executed individually or collectively by the at least one processor, cause the server to, based on that the host terminal of the chat room includes a first host terminal and a second host terminal, determine a second area determined based on a position of the second host terminal to be the join area together with a first area determined based on a position of the first host terminal.

The instructions, when executed individually or collectively by the at least one processor, cause the server to, based on receiving, from the host terminal, an addition request of a join area based on another user account that joins the chat room, add an area determined based on a position of the other user account to the join area.

The instructions, when executed individually or collectively by the at least one processor, cause the server to, in response to a first activation request received from the host terminal, determine a first join area based on a first position of the host terminal at a first time point corresponding to the first activation request, based on at least one of a deactivation request to deactivate the position-based chat room entry function received from the host terminal or elapse of a predetermined time from the first time point, deactivate the position-based chat room entry function of the chat room based on the first activation request, based on receiving a second activation request with respect to the chat room from the host terminal after deactivation, determine a second join area based on a second position of the host terminal at a second time point corresponding to the second activation request, and activate the position-based chat room entry function of the chat room to allow a guest account of a guest terminal positioned in at least one of the first join area or the second join area to enter the chat room.

The instructions, when executed individually or collectively by the at least one processor, cause the server to, while an entry function to the chat room is activated, based on detecting a position change of the host terminal, change the join area based on a changed position of the host terminal.

In sum, the present disclosure provides a computer-implemented method and server architecture that enhance the operation of instant messaging systems by integrating real-time positional sensing, dynamic area determination, and encrypted credential exchange. In contrast to conventional systems requiring link-based invitations, the disclosed system enables automatic entry control based on verified device positions and temporary join credentials. This reduces user-side authentication latency, minimizes unnecessary server queries, and strengthens message confidentiality by binding cryptographic operations to verified spatial contexts.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

FIG. 1 illustrates an example of an instant messaging system according to an embodiment.

FIG. 2 is a flowchart of an example of a position-based chat room entry function provided by an instant messaging system according to an embodiment.

FIG. 3A illustrates an example of an interface displayed while a user terminal generates a chat room and activates a chat room entry function according to an embodiment.

FIG. 3B illustrates an example of an interface displayed while a user terminal activates a position-based chat room entry function according to an embodiment.

FIG. 4 illustrates an example of an interface displayed while a user terminal enters a chat room in which a position-based chat room entry function is activated according to an embodiment.

FIG. 5 is a flowchart of an example of adding a guest account to a chat room by a server in response to a request to join the chat room according to an embodiment.

FIG. 6 illustrates an example of adding a join area based on a position of a terminal of another user account according to an embodiment.

FIG. 7 illustrates an example of determining a join area based on a previous join area determined based on a previous activation request according to an embodiment.

FIG. 8 is a system view of an example of operations of an instant messaging system providing a secured instant messaging service according to an embodiment.

FIG. 9 illustrates an example of a hardware configuration of a system for an instant messaging service according to an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The embodiments described herein are not directed to merely organizing human interactions or providing chat rooms in a conventional sense. Rather, the disclosed method implements a specific network control process that (1) defines and dynamically updates a join area using real-time positional information obtained from mobile device sensors such as a global positioning system (GPS), Bluetooth, near field communication (NFC), or ultrasound transceivers; (2) applies conditional activation logic and temporary join codes that are automatically expired or reissued based on timing events managed by the server; and (3) transmits encrypted access information associated with those join codes. These coordinated operations collectively improve the technical operation of communication systems by automating and securing session access, rather than relying on abstract social or administrative concepts.

The disclosed configuration further embodies a defined technological architecture that provides measurable improvements in computer networking. Specifically, it (1) reduces network overhead and host-side verification by enabling automated entry based on sensor-verified device proximity; (2) enhances data security through join-code-based encryption of communication credentials, thereby removing the need for manual key exchange; and (3) increases server-side efficiency by limiting activation time and join radius to prevent unauthorized or stale connections. These coordinated effects constitute a practical application of computing and communication resources and yield improvements in the functioning of networked computer systems as a whole.

Hereinafter, embodiments will be described in detail with reference to the accompanying drawings. When describing the embodiments with reference to the accompanying drawings, like reference numerals refer to like elements and a repeated description related thereto will be omitted.

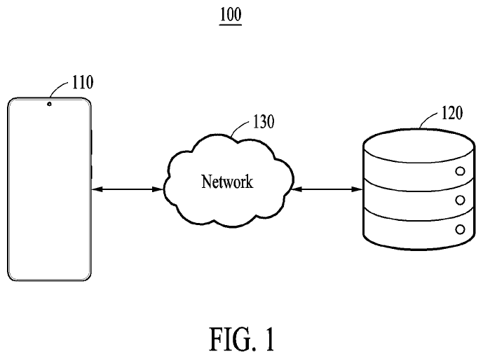

FIG. 1 illustrates an example of an instant messaging system according to an embodiment.

An instant messaging system 100 according to an embodiment may include a user terminal 110, a server 120, and a network 130.

The user terminal 110 may be one of electronic devices, such as a computer, a portable computer, a wireless phone, a mobile phone, a smartphone, a personal digital assistant (PDA), a web tablet, and a wearable device, and may refer to any device that may install or execute an application (hereinafter, also referred to as an “app”) associated with the server 120 or execute a web. In this case, the user terminal 110 may perform the overall operation of a service, such as configuring a service screen, inputting data, transmitting and receiving data, and storing data, under the control of the app or web. The user terminal 110 may process a user interface or user interaction via a processor and may output or transmit a processing result via an output device of the user terminal 110.

The user terminal 110 may execute an app or web associated with a service provided by the server 120. The user may use a service provided by the server 120 by executing the app or web associated with the service via the user terminal 110.

The server 120 may include an instant messaging service (IMS) via the network 130, a social networking service, and/or an a server providing the IMS.

The server 120 may provide a service to the user terminal 110. According to an embodiment, the server 120 may include an instant messaging server (not shown). The instant messaging server may provide an IMS to the user terminal 110.

The IMS may refer to a messenger service in which a user transmits and receives text, a picture, voice, and the like in real time via a network. The IMS may be installed in a terminal of a user in the form of an app and/or a program to provide the IMS.

The IMS may provide a chat room in which the user may transmit and receive a message including data, such as text, to and from a partner designated by the user. The IMS may provide the user with a function to provide a message by displaying data transmitted and received via the chat room. One or more users may join one chat room. For example, only a single user may join one chat room. In other words, the user may generate a chat room with themselves (or their own chat room) and/or may transmit and receive a message via the chat room with themselves. The user joining the chat room may share the content of the message, such as text and a picture transmitted and received in the chat room.

The IMS may generate a user-wise account according to a registration procedure. The IMS may manage a chat room and a message corresponding to the account of the user. The user may transmit and receive a message via a chat room with other users who register for the IMS, via the account generated as the user registers to the IMS.

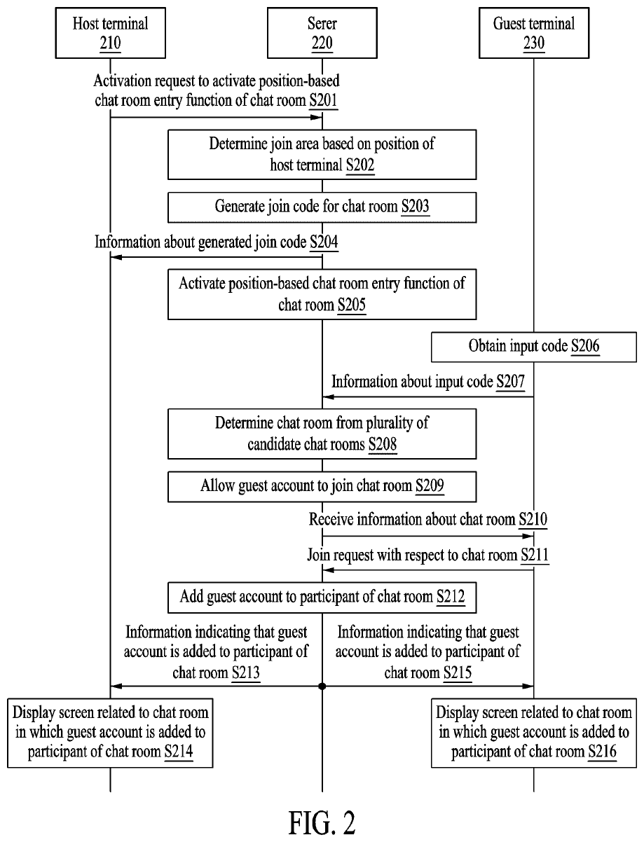

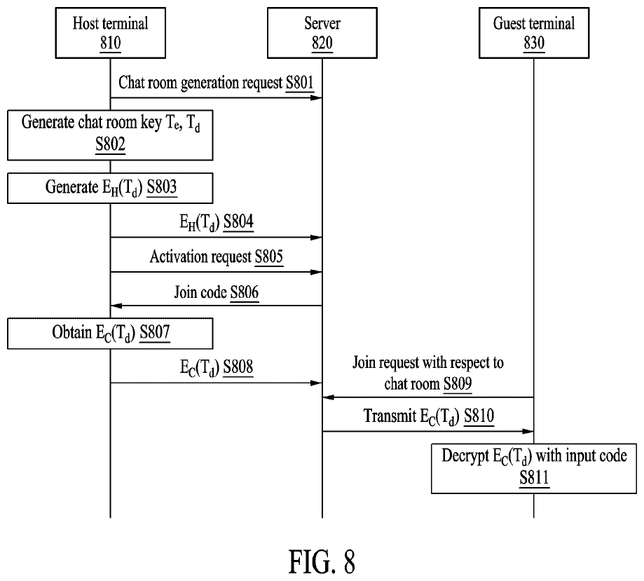

As described with reference to FIGS. 2 to 9 below, an instant messaging server may provide a position-based chat room entry function and/or a secured IMS. The position-based chat room entry function may refer to a function that allows the user terminal 110 to enter a specific chat room based on that the user terminal 110 is positioned in an area (e.g., a join area) determined for the specific chat room. The position-based chat room entry function is further described with reference to FIGS. 2 to 7. The secured IMS may be an IMS with enhanced security and may include an IMS that encrypts data and transmits and receives the encrypted data. The secured IMS is further described with reference to FIG. 8 below.

The server 120 may be linked to an app associated with a service executed by the user terminal 110 or web associated with the service for a user interface (UI), a function, an operation, or the service.

The user account may be generated by registering to a service provided by the server 120, and the server 120 may function as a service platform that provides the service to the user account registered to the service, such as a social networking service (SNS) or an IMS. In the embodiments of the present disclosure, the user account is mainly described as an account registered to an IMS. Since the user terminal 110 uses the service using the user account, the user account included the below embodiments may correspond to the user terminal 110.

In the embodiments of the present disclosure, the “user” may refer to not only a user as a natural person but also a user account registered to an IMS or a user terminal accessing with the user account. A “host” may refer to a natural person having the authority to generate and/or manage a chat room and may be construed as a user account of the host (hereinafter, also referred to as a “host account”) or a user terminal of the host (hereinafter, also referred to as a “host terminal”) in addition to the natural person. A “guest” may be a natural person sending a request to join a chat room generated and/or managed by the host and may be construed as a user account of the guest (hereinafter, also referred to as a “guest account”) or a user terminal of the guest (hereinafter, also referred to as a “guest terminal”).

FIG. 2 is a flowchart of an example of a position-based chat room entry function provided by an instant messaging system according to an embodiment.

An instant messaging system (e.g., the instant messaging system 100 of FIG. 1) may include a host terminal 210, a server 220 (e.g., the server 120 of FIG. 1), and a guest terminal 230.

The host terminal 210 may refer to a user terminal (e.g., the user terminal 110 of FIG. 1) that uses an IMS using the host account (e.g., accessing the IMS). The host account may refer to a user account designated as a host among one or more user accounts joining a specific chat room. For example, the host account may refer to a user account that generates a specific chat room and/or is designated as an additional host account by a host account of a specific chat room.

The guest terminal 230 may refer to a user terminal (e.g., the user terminal 110 of FIG. 1) using the IMS (e.g., accessing the IMS) using the guest account. The guest account may refer to a user account that joins the specific chat room. For example, the guest account may refer to a user account that did not join the specific chat room and newly joins.

In the embodiments of the present disclosure, the host terminal 210 (or the host account) and the guest terminal 230 (or the guest account) may be terms indicating positions granted with respect to the specific chat room. Accordingly, a first user account may be a host account of a first chat room as well as a guest account of a second chat room, and a second user account may be a guest account of the first chat room as well as a host account of the second chat room. In addition, a specific user account may be host accounts of two or more chat rooms and/or guest accounts of two or more chat rooms.

In the embodiments of the present disclosure, operations of the host terminal 210 (or the host account) and the guest terminal 230 (or the guest account) with respect to the specific chat room are mainly described. However, with respect to multiple chat rooms which the user account joins, one user terminal may perform an operation as the host terminal 210 for the first chat room while performing an operation as the guest terminal 230 for the second chat room.

In operation S201, the host terminal 210 may transmit an activation request to the server 220 to activate a position-based chat room entry function in a chat room in response to a user input (e.g., an input by a host).

In operation S202, in response to the activation request, the server 220 may determine a join area based on a position of the host terminal 210.

For example, the server 220 may determine an area (e.g., a two-dimensional (2D) area or a three-dimensional (3D) area) within a predetermined radius (e.g., a radius of 3 meters (m)) from the position of the host terminal 210 to be the join area.

According to an embodiment, the host terminal 210 may obtain position information indicating the geographic position of the host terminal 210 using a sensor (e.g., a global positioning system (GPS) sensor or a global navigation satellite system (GNSS) sensor) included in the host terminal 210. The host terminal 210 may transmit the position information of the host terminal 210 to the server 220. The server 220 may determine the join area based on the position information of the host terminal 210, received from the host terminal 210.

In the embodiments of the present disclosure, the host terminal 210 of the chat room is mainly described as one terminal, but the embodiments are not limited thereto. According to an embodiment, the host terminal 210 of the chat room may include a plurality of terminals.

Based on that the host terminal 210 of the chat room includes the first host terminal and a second host terminal, the server 220 may determine a second area determined based on a position of the second host terminal to be the join area in addition to a first area determined based on a position of the first host terminal.

The first host terminal may be a terminal accessing an IMS with a first host account, and the second host terminal may be a terminal accessing the IMS with a second host account that is different from the first host account. For reference, as described with reference to FIG. 1 above, the user account generating the chat room may be designated as the host account of the chat room. Thereafter, the user account, which is the host account of the chat room, may designate another user account joining the chat room as an additional host account. As a result, for one chat room, multiple host accounts may exist.

However, the example is not limited thereto, and the first host terminal and the second host terminal may be terminals accessing the IMS with the same host account. In other words, when there are the first host terminal (e.g., a smartphone) and the second host terminal (e.g., a laptop) logged in with the host account of the chat room, the first area may be determined based on the position of the first host terminal, and the second area may be determined based on the position of the second host terminal.

In operation S203, the server 220 may generate a join code for the chat room in response to the activation request. The server 220 may generate a unique join code for the activation request. The join code may be valid only while the position-based chat room entry function is activated in response to the activation request. The join code may become invalid when the position-based chat room entry function is deactivated corresponding to the activation request.

For example, the position-based chat room entry function of the chat room may be activated in response to a first activation request, and then may be deactivated. Thereafter, the position-based chat room entry function of the chat room may be activated in response to a second activation request following the first activation request, and then may be deactivated. The join code corresponding to the first activation request may be invalid, even when the chat room entry function of the same chat room is activated by the second activation request. Accordingly, while the chat room entry function is activated by the second activation request, a guest account that inputs the join code corresponding to the second activation request may be allowed to enter the chat room and a guest account that inputs the join code corresponding to the first activation request may be rejected (e.g., restricted) to enter the chat room.

According to an embodiment, in the position-based chat room entry function, to prevent an unintended user account from entering the chat room when entering the chat room is allowed only with the position of the user terminal, the server 220 may allow a user account that enters the join code of the chat room while the position of the user terminal is in the join area, to enter the chat room.

In operation S204, the server 220 may transmit information about the generated join code to the host terminal 210. The host terminal 210 may receive the information about the join code for the chat room from the server 220. The host terminal 210 may display the join code on a display.

A user (e.g., a host) of the host terminal 210 may notify a user (e.g., a guest) of the guest terminal 230 of the join code. When the host and the guest are physically in the same space (e.g., a conference room), the host may transmit the join code to the guest. As described below, the guest may enter the chat room by inputting the join code received from the host to the guest terminal 230.

In operation S205, the server 220 may activate the position-based chat room entry function of the chat room based on the join area and the join code.

The server 220 may generate information about the chat room (e.g., a chat room identifier (ID)) and an entry including the join code while the position-based chat room entry function of the chat room is activated. The server 220 may add the generated entry to a database. For example, the entry may further include information about the join area in addition to the information about the chat room and the join code. The database may refer to a database for storing entries of a plurality of candidate chat rooms in which the position-based chat room entry function is activated. The database may be included in the server 220 (e.g., an internal database) or may be included in an external device (e.g., an external database) accessible by the server 220.

In operation S206, the guest terminal 230 may obtain an input code to enter the chat room using the position-based chat room entry function. The input code may be input by the user (e.g., the guest). As described above, the guest may be in the same physical space with the host. The host may notify the guest of the join code displayed by the host terminal 210. The guest may input the join code provided by the host to the guest terminal 230 as the input code.

In operation S207, the guest terminal 230 may transmit information about the input code to the server 220. The server 220 may receive the information about the input code from the guest terminal 230.

In operation S208, the server 220 may determine (e.g., select or check) a chat room having the same join code as the input code from a plurality of candidate chat rooms with activated position-based chat room entry functions.

For example, the server 220 may retrieve the input code from join codes of entries of the plurality of candidate chat rooms of the database. When a target entry including the same join code as the input code exists in the database, the server 220 may obtain information about the chat room included in the target entry. When the target entry including the same join code as the input code does not exist in the database, the server 220 may transmit, to the guest terminal 230, the information indicating that the chat room corresponding to the input code does not exist in the plurality of candidate chat rooms. The guest terminal 230 may display a notification message to request for confirmation of the input code.

In operation S209, the server 220 may allow the guest account to join the chat room based on that the guest terminal 230 is positioned in the join area of the determined chat room.

The server 220 may determine whether the guest terminal 230 is positioned in the join area of the chat room based on at least one of the position information of the guest terminal 230, ultrasound waves (e.g., inaudible sound waves), or short range wireless communication (e.g., Bluetooth or near field communication (NFC)).

For example, the server 220 may receive the position information of the guest terminal 230 from the guest terminal 230. The guest terminal 230 may obtain position information indicating the geographic position of the guest terminal 230 using a sensor (e.g., a GPS sensor or a GNSS sensor). Together with the information about the input code or after the chat room having the same join code as the input code is determined, the guest terminal 230 may transmit the position information of the guest terminal 230 to the server 220. The server 220 may determine whether the guest terminal 230 is positioned in the join area based on the position information of the guest terminal 230.

For example, the server 220 may transmit a command to radiate ultrasound waves to the host terminal 210 based on the activation of the position-based chat room entry function of the chat room. The host terminal 210 may radiate ultrasound waves while the position-based chat room entry function is activated. In this case, the join area may be determined to be an area where the ultrasonic waves radiated by the host terminal 210 are received. When the guest terminal 230 receives the ultrasonic waves radiated by the host terminal 210, the guest terminal 230 may transmit information about the ultrasonic waves radiated to the server 220. Based on the information about the ultrasonic waves received from the guest terminal 230 and the information about the ultrasonic waves radiated by the host device 210, when the information about the ultrasonic waves received from the guest terminal 230 coincides with the information about the ultrasonic waves radiated by the host terminal 210, the server 220 may determine that the guest terminal 230 is positioned in the join area.

For example, the server 220 may determine whether the guest terminal 230 is positioned in the join area using NFC. When the server 220 receives information indicating transmission and reception of a communication signal via NFC between the host terminal 210 and the guest terminal 230 from the host terminal 210 and/or the guest terminal 230, the server 220 may determine that the guest terminal 230 is positioned in the join area. For example, the host terminal 210 may broadcast an advertisement packet of Bluetooth communication while the position-based chat room entry function is activated. The guest terminal 230 may scan the advertisement packet after transmitting the information about the input code or determining the chat room having the same join code as the input code. The guest terminal 230 may transmit the information about reception of the advertisement packet from the host terminal 210 to the server 220. The server 220 may determine that the guest terminal 230 is positioned in the join area based on that the guest terminal 230 receives the advertisement packet from the host terminal 210.

When the guest terminal 230 is positioned in the join area of the determined chat room, the server 220 may allow the guest account to join the chat room.

Although not explicitly shown in FIG. 2, the server 220 may restrict the guest account to join the chat room based on that the guest terminal 230 is not positioned in the join area of the determined chat room.

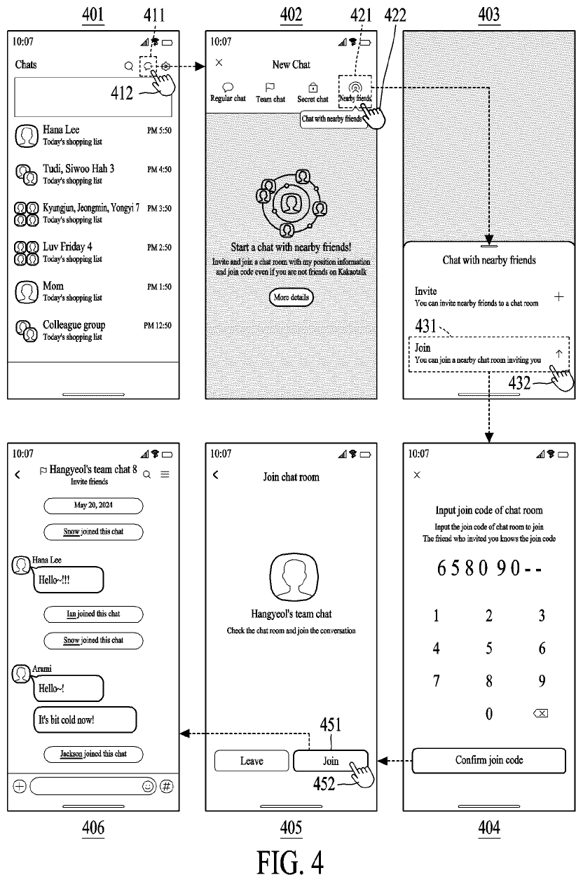

In operation S210, the server 220 may transmit the information about the determined chat room to the guest terminal 230. The guest terminal 230 may receive the information about the determined chat room from the server 220. The guest terminal 230 may display a screen to enter the chat room using the received information about the chat room from the server 220. The screen to enter the chat room may include the information about the chat room and a join button to join the chat room. The screen to enter the chat room is further described with reference to FIG. 4.

In operation S211, the guest terminal 230 may transmit a join request to join the chat room to the server 220. The guest terminal 230 may transmit the join request to the server 220 based on receiving a user input (e.g., an input of the guest) to select a join button in the screen to enter the chat room. The server 220 may receive the join request with respect to the chat room from the guest terminal 230.

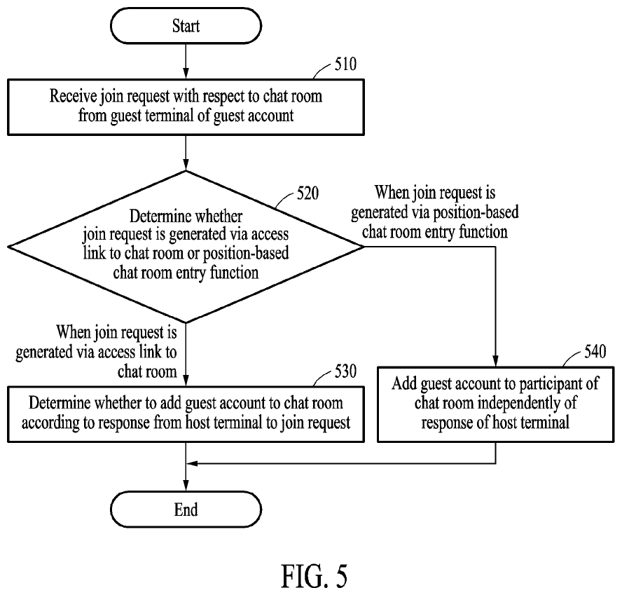

In operation S212, the server 220 may add a guest account to a participant of the chat room based on receiving the join request with respect to the chat room from the guest terminal 230. The server 220 may add the guest account to the participant of the chat room independently of a response of the host terminal 210 to the join request, based on the join request generated via the position-based chat room entry function. As described below with reference to FIG. 5, when the join request with respect to the chat room is generated via an accessible link to the chat room, the server 220 may determine whether to allow the guest account to join based on the response of the host terminal 210 to the join request.

The server 220 may transmit information indicating that the guest account is added to the participant of the chat room to the host terminal 210 and the guest terminal 230. The information indicating that the guest account is added to the participant of the chat room may include information to display a screen related to the chat room in which a user terminal (e.g., the host terminal 210 or the guest terminal 230) is added to the chat room as a participant.

In operation S213, the server 220 may transmit the information indicating that the guest account is added to the participant of the chat room to the host terminal 210. The host terminal 210 may receive the information indicating that the guest account is added to the participant of the chat room from the server 220.

In operation S214, based on that the guest account joins the chat room, the host terminal 210 may display a screen related to the chat room in which the guest account is added as a participant.

In operation S215, the server 220 may transmit the information related to the addition of the guest account to the participant of the chat room to the guest terminal 230. The guest terminal 230 may receive the information indicating that the guest account is added to the participant of the chat room from the server 220.

In operation S216, the guest terminal 230 may display the screen related to the chat room in which the guest account is added to the participant of the chat room based on that the guest account joins the chat room.

According to an embodiment, the position of the host terminal 210 may be changed while the chat room entry function is activated. In response to detecting a change in the position of the host terminal 210, the server 220 may change the join area based on the changed position of the host terminal 210. The server 220 may update the join area based on a real-time position of the host terminal 210.

For example, when the join area is determined to be an area within a radius of 3 m from the position of the host terminal 210, at each time point, the join area may be determined to be the area within a radius of 3 m from the position of the host terminal 210 at the time point.

However, the change in the join area according to the embodiments of the present disclosure is not limited to the change based on the position change of the host terminal 210. The join area according to an embodiment may be determined based on the position of the host terminal 210 at a time point when the activation request is generated, and even if the position of the host terminal 210 is changed after the activation request is generated, the join area may not be changed.

According to an embodiment, the position-based chat room entry function of the chat room may be deactivated in response to a deactivation request of the host terminal 210 or elapse of a predetermined time (e.g., 5 minutes) after the time point when the activation request is generated. As described above, when the position-based chat room entry function of the chat room is deactivated, the join code and/or the join area may be set to invalid. The server 220 may delete the entry of the chat room included in the database, based on deactivation of the position-based chat room entry function of the chat room.

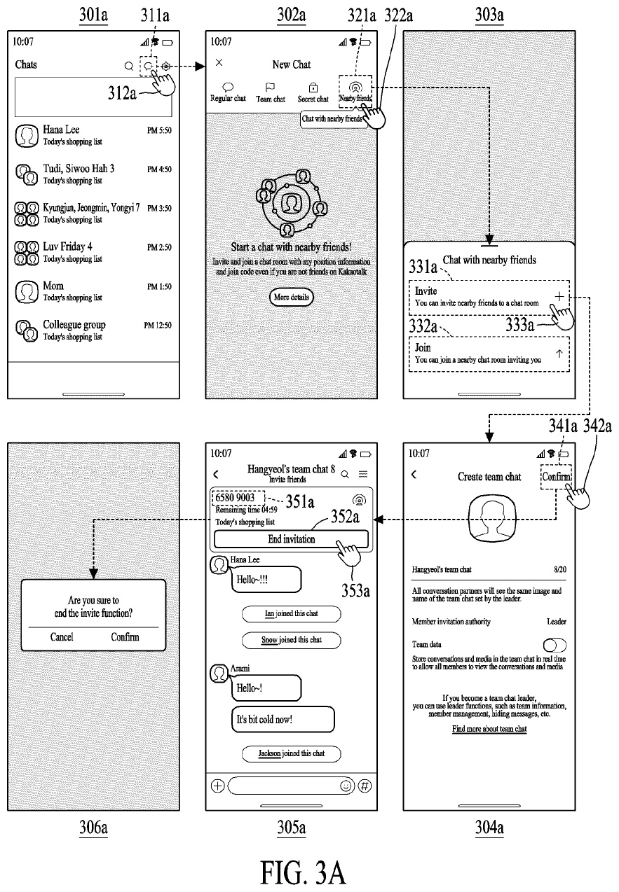

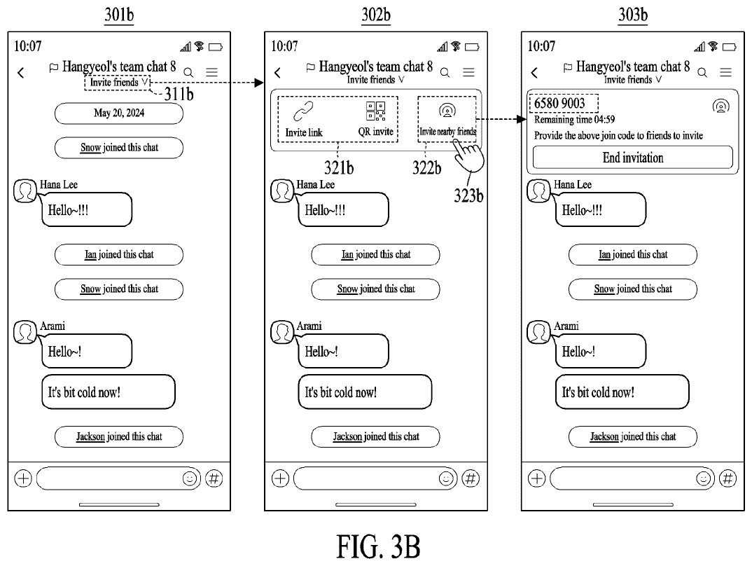

FIG. 3A illustrates an example of an interface displayed while a user terminal generates a chat room and activates a chat room entry function according to an embodiment.

A user terminal (e.g., the user terminal 110 of FIG. 1 or the host terminal 210 of FIG. 2) according to an embodiment may generate a chat room and may activate a position-based chat room entry function of the generated chat room.

On a screen 301a, the user terminal may display a chat room list screen. The chat room list screen may include a button 311a to add a chat room. The user terminal may obtain a user input 312a to select the button 311a. The user terminal may display a chat room addition menu screen in response to the user input 312a.

On a screen 302a, the user terminal may display the chat room addition menu screen. The chat room addition menu screen may include a button 321a corresponding to position-based chat room addition. The user terminal may obtain a user input 322a to select the button 321a. The user terminal may display a position-based chat room addition menu screen in response to the user input 322a.

On a screen 303a, the user terminal may display the position-based chat room addition menu screen. According to an embodiment, the position-based chat room addition menu screen may include an invite button 331a and a join button 332a. The invite button 331a may provide a function to generate a chat room and activate a position-based chat room entry function of the generated chat room to allow other user accounts to join the generated chat room. The join button 332a may provide a function to enter the chat room in which the position-based chat room entry function is activated. In FIG. 3A, the user terminal may obtain a user input 333a to select the invite button 331a. The user terminal may display a chat room generation screen in response to the user input 333a.

On a screen 304a, the user terminal may display the chat room generation screen. The user terminal may input information (e.g., a representative image or name of the chat room) about the chat room through the chat room generation screen. The user terminal may transmit a chat room generation request to the server in response to a user input 342a to select a confirm button 341a of the chat room generation screen. In response to the chat room generation request, the server may generate the chat room and may set the user account to a host account of the generated chat room.

The user terminal may transmit an activation request to activate the position-based chat room entry function of the chat room to the server. In response to the activation request, the server may generate a join code and may transmit the generated join code to the user terminal.

On a screen 305a, the user terminal may display a chat room interface. The user terminal may display a join code 351a based on information about the join code received from the server. A host (e.g., a user of the user terminal) may notify other users (e.g., guests) in the same physical space of the join code displayed on the user terminal. The user terminal may further include an invitation termination button 352a. The invitation termination button 352a may provide a function to deactivate the position-based chat room entry function of the chat room. In response to a user input 353a to select the invitation termination button 352a, the user terminal may display an invitation termination confirm menu.

On a screen 306a, the user terminal may display an invitation termination confirm menu. The invitation termination confirm menu may include a cancel button and a confirm button. The cancel button may provide a function (e.g., a function to cancel the user input 353a) to maintain activation of the position-based chat room entry function. The confirm button may provide a function to immediately deactivate the position-based chat room entry function.

FIG. 3B illustrates an example of an interface displayed while a user terminal activates a position-based chat room entry function according to an embodiment.

A user terminal (e.g., the user terminal 110 of FIG. 1 or the host terminal 210 of FIG. 2) according to an embodiment may activate a position-based chat room entry function of a chat room in which a user account is a host account.

On a screen 301b, the user terminal may display a chat room interface of the chat room. The chat room interface may include an invite button 311b. The invite button 311b may provide a function to invite other user accounts to the chat room corresponding to the chat room interface. The user terminal may display an invitation menu in response to a user input 312b to select the invite button 311b.

On a screen 302b, the user terminal may display the invitation menu. The invitation menu may include a link-based invite button 321b and a position-based invite button 322b. The link-based invite button 321b may provide a function to generate and/or transmit an access link to the chat room or a quick response (QR) code. The position-based invite button 322b may provide a function to activate the position-based chat room entry function. The user terminal may obtain a user input 323b to select the position-based invite button 322b. In response to the user input 323b, the user terminal may transmit an activation request to activate the position-based entry function of the chat room to the server. In response to the activation request, the server may generate a join code and may transmit the generated join code to the user terminal.

On a screen 303b, the user terminal may display information about the join code. As or similar to the screen 305a of FIG. 3A, the user terminal may display the information about the join code, and a user (e.g., the host) of the user terminal may notify other users (e.g., guests) in the same physical space of the join code displayed on the user terminal. The user accounts of other users (e.g., guests) may enter the chat room via the join code.

FIG. 4 illustrates an example of an interface displayed while a user terminal enters a chat room in which a position-based chat room entry function is activated according to an embodiment.

According to an embodiment, a user terminal (e.g., the user terminal 110 of FIG. 1 or the guest terminal 230 of FIG. 2) according to an embodiment may enter a chat room in which a position-based chat room entry function is activated.

On a screen 401, the user terminal may display a chat room list screen. The chat room list screen may include a button 411 to add a chat room. The user terminal may obtain a user input 412 to select the button 411. The user terminal may display a chat room addition menu screen in response to the user input 412.

On a screen 402, the user terminal may display the chat room addition menu screen. The chat room addition menu screen may include a button 421 corresponding to position-based chat room addition. The user terminal may obtain a user input 422 to select the button 421. The user terminal may display a position-based chat room addition menu screen in response to the user input 422.

On a screen 403, the user terminal may display the position-based chat room addition menu screen. According to an embodiment, the position-based chat room addition menu screen may include an invite button (e.g., the invite button 331a of FIG. 3A) and a join button 431 (e.g., the join button 322a of FIG. 3A). In FIG. 4, the user terminal may obtain a user input 432 to select an invite button 431. In response to the user input 432, the user terminal may display an input code input screen.

On a screen 404, the user terminal may obtain an input code from the user. The user terminal may transmit information about the obtained input code to the server. Based on the input code, the server may select a chat room having the same join code as the input code. Based on that the user terminal is positioned in a join area of the selected chat room, the server may allow the user account to join the chat room. The server may transmit information about the chat room to the user terminal.

On a screen 405, the user terminal may display a screen to enter the chat room based on the information about the chat room received from the server. The screen to enter the chat room may include the information (e.g., a representative image or name of the chat room) about the chat room. The screen to enter the chat room may include a join button 451. In response to a user input 452 to select the join button 451, the user terminal may transmit a join request to the server. The server may add the user account to a participant of the chat room based on receiving the join request from the user terminal.

On a screen 406, the user terminal may display a screen related to the chat room in which the user account is added to the participant of the chat room.

FIG. 5 is a flowchart of an example of adding a guest account to a chat room by a server in response to a request to join the chat room according to an embodiment.

A server (e.g., the server 120 of FIG. 1 or the server 220 of FIG. 2) according to an embodiment may determine whether a response of a host terminal (e.g., the host terminal 210 of FIG. 2) is required to add a guest account to a participant of a chat room based on how a join request is generated.

In operation 510, the server may receive a join request to join a chat room from a guest terminal (e.g., the guest terminal 230 of FIG. 2) of the guest account.

For the chat room in which the position-based chat room entry function is activated as mainly described with reference to FIGS. 1 to 4, the join request to join the chat room may be received from the guest terminal that transmits an input code, which is the same as a join code of the chat room, and is positioned in a join area of the chat room. However, the join request to join the chat room is not limited to being generated through the position-based chat room entry function, and the join request to join the chat room may be generated through an access link to the chat room.

According to an embodiment, the host terminal may generate and/or distribute the access link to the chat room. For example, as shown in the screen 302b of FIG. 3B, based on the link-based invite button (e.g., the link-based invite button 321b), the user terminal may request the server to generate an access link to the chat room and may receive the generated link from the server. The user terminal may transmit the access link to the chat room to the guest account. The guest terminal may transmit a join request to join the chat room via the link to the server.

In operation 520, the server may determine whether the join request is generated via the access link to the chat room or is generated via the position-based chat room entry function.

In operation 530, the server may determine whether to add the guest account to the chat room in response to a response of the host terminal to the join request, based on that the join request is generated via the access link to the chat room.

When the join request is generated via the access link to the chat room, the server may transmit an approval request for the join request to the host terminal. The approval request may include at least one of the information about the chat room (e.g., a chat room ID), the information about the guest account (e.g., a profile of the guest account), or information about the approval request (e.g., the time when the join request is generated or the generation scheme of the join request). The host terminal may transmit, to the server, either an acceptance response or a rejection response to the approval request as a response of the host terminal to the join request.

The server may add the guest account to the participant of the chat room based on receiving the acceptance response. The server may restrict to add the guest account to the participant of the chat room based on receiving the rejection response.

In operation 540, the server may add the guest account to the participant of the chat room independently of the response of the host terminal, based on that the join request is generated via the position-based chat room entry function.

The join request generated via the position-based chat room entry function may be generated when the join code transmitted to the host terminal is input via the guest terminal as an input code and the guest terminal is positioned near the host terminal, as described with reference to FIG. 2. The host of the chat room may provide the join code of the chat room only to the guest allowed to enter the chat room, and the server may add the guest account that inputs the input code the same as the join code to the participant of the chat room without a response from the host terminal.

According to an embodiment, when the host of the chat room invites guests in the same physical space to the chat room, the host may invite the guests in the same physical space by activating the position-based chat room entry function and providing the join code to the guests instead of transmitting the link for the chat room to each guest and accepting the join request. In addition, even when a friend relationship is not established between the host account and the guest account, the guest account may enter the chat room only with the join code (or input code) and the position without adding the guest account as a friend by the host account. Accordingly, when using the position-based chat room entry function, an unnecessary friend relationship between the host account and the guest account may not need to be set to invite the guest account to the chat room.

When receiving a plurality of join requests with respect to the same chat room, the server according to the embodiments of the present disclosure may differently process whether a response from the host terminal is required to add the guest account to the participant of the chat room according to a generation scheme of each of the join requests.

For example, the server may receive a first join request with respect to a chat room from a first guest terminal. The server may receive a second join request with respect to the chat room from a second guest terminal. The server may add the first guest account of the first guest terminal to a participant of the chat room independently of a response from the host terminal (e.g., regardless of the response from the host terminal), based on that the first join request is generated via the position-based chat room entry function. The server may determine whether the add the guest account to the chat room in response to a response from the host terminal to the second join request, based on that the second join request is generated via an access link to the chat room.

When transmitting join requests with respect to a plurality of chat rooms to the server, the guest terminal according to the embodiments of the present disclosure may differently process whether the response from the host terminal is required to add the guest account to the participant of the chat room according to the generation scheme of each of the join requests.

The guest terminal may transmit a first join request with respect to a first chat room to the server. The server may add the guest account to the participant of the chat room independently of the response from the host terminal of the first chat room to the first join request, based on that the first join request with respect to the first chat room is generated based on the position-based chat room entry function.

The guest terminal may transmit a second join request to a second chat room to the server. The guest account may be added to the participant of the second chat room in response to the response from the host terminal of the second chat room, based on that the second join request is generated via an access link to the second chat room. The guest account may be added to the participant of the second chat room independently of the response from the host terminal of the second chat room, based on that the second join request is generated via the position-based chat room entry function.

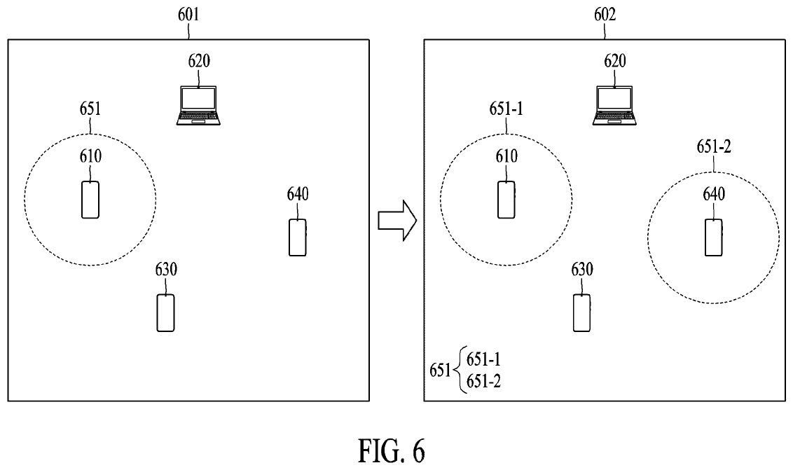

FIG. 6 illustrates an example of adding a join area based on a position of a terminal of another user account according to an embodiment.

A host terminal 610 (e.g., the host terminal 210 of FIG. 2) may transmit an activation request to activate a position-based chat room entry function of a chat room to a server (e.g., the server 120 of FIG. 1 or the server 220 of FIG. 2). For example, referring to FIG. 6, four user accounts (e.g., first, second, third, and fourth user accounts) may have joined a chat room. The host terminal 610 may be a terminal logged in with the first user account, which is a host account of the chat room. A user terminal 620 may be a terminal logged in with the second user account. A user terminal 630 may be a terminal logged in with the third user account. A user terminal 640 may be a terminal logged in with the fourth user account.

In a situation 601, the server may determine a join area 651 based on a position of the host terminal 610.

According to an embodiment, the host terminal 610 may request to expand the join area 651 based on other user accounts in the chat room. For example, the host terminal 610 may request to expand the join area 651 based on the fourth user account.

The host terminal 610 may transmit an addition request of the join area 651 based on other user accounts in the chat room to the server. The addition request of the join area 651 may include information about the chat room (e.g., a chat room ID) and information about the other user account (e.g., the fourth user account) and/or the user terminal 640 logged in with the other user account. The server may receive the addition request of the join area 651 from the host terminal 610.

In a situation 602, the server may add an area 651-2 to the join area 651 based on receiving the addition request of the join area 651 from the host terminal 610, wherein the area 651-2 is determined based on the position of the user terminal 640 of the other user account. The server may determine the area 651-2 based on the position of the user terminal 640 logged in with the other user account (e.g., the fourth user account) in response to the addition request of the join area 651. The server may change the join area 651 by adding the area 651-2 determined based on the position of the user terminal 640 of the other user account to an area 651-1 determined based on the position of the host terminal 610.

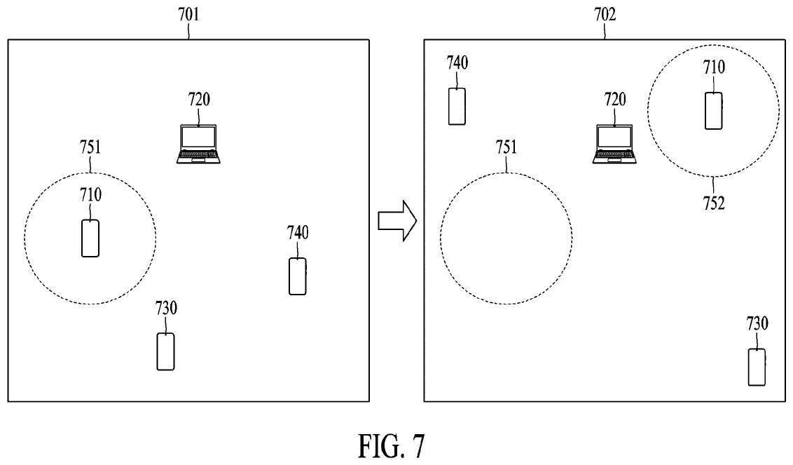

FIG. 7 illustrates an example of determining a join area based on a previous join area determined based on a previous activation request according to an embodiment.

According to an embodiment, when a position-based chat room entry function of a chat room is activated multiple times based on multiple activation requests corresponding to multiple time points, a join area corresponding to each activation request may be determined based on a join area determined corresponding to a previous activation request.

Referring to FIG. 7, four user accounts (e.g., first, second, third, and fourth user accounts) may have joined a chat room. A host terminal 710 may be a terminal logged in with the first user account, which is a host account of the chat room. A user terminal 720 may be a terminal logged in with the second user account. A user terminal 730 may be a terminal logged in with the third user account. A user terminal 740 may be a terminal logged in with the fourth user account.

The host terminal 710 according to an embodiment may transmit a first activation request at a first time point. In a situation 701, in response to the first activation request received from the host terminal 710, the server may determine a first join area 751 based on a first position of the host terminal 710 at the first time point corresponding to the first activation request.

The server may deactivate the position-based chat room entry function of the chat room based on the first activation request, based on at least one of a deactivation request to deactivate the position-based chat room entry function received from the host terminal 710 or elapse of a predetermined time from the first time point.

After deactivation, the host terminal 710 may transmit a second activation request with respect to the chat room to the server at a second time point. In a situation 702, the server may determine a second join area 752 based on a second position of the host terminal 710 at the second time point corresponding to the second activation request, based on receiving the second activation request with respect to the chat room from the host terminal 710 after deactivation.

The server may activate the position-based chat room entry function to allow the guest account of the guest terminal in at least one of the first join area 751 or the second join area 752 to enter the chat room. In other words, the position-based chat room entry function of the chat room based on the second activation request may process the guest account of the guest terminal in at least one of the first join area 751 or the second join area 752 to enter the chat room.

FIG. 8 is a system view of an example of operations of an instant messaging system providing a secured IMS according to an embodiment.

According to an embodiment, an instant messaging system (e.g., the instant messaging system 100 of FIG. 1) may provide a secured IMS.

Transmitted or received data and/or stored data in the instant messaging system may be encrypted data for security. More specifically, the transmitted or received data and/or stored data via the instant messaging system may be encrypted by a sender. The transmitted or received data and/or stored data via the instant messaging system may be encrypted so that a designated recipient decrypts the data. The designated recipient may include a user designated as a target to receive the data in various manners. For example, the designated recipient may be designated by the sender, may be automatically designated as the recipient belongs to a specific group, or a user included in a chat room in which the data is transmitted in the secured IMS may be designated as a recipient. In the IMS, since the transmitted or received data via a server 820 and/or data stored in the server 820 is encrypted data, the server 820 and a third party accessing the server 820 may not refer or forge/falsify the original data, thereby providing a secured IMS with enhanced security.

In the secured IMS, a message transmitted via the chat room may be encrypted via a message key and may be stored in the server 820. In the embodiments of the present disclosure, the key used to encrypt the message may be a symmetric key and may be referred to as a message key. The symmetric key may indicate that a key used for encryption is the same as a key used for decryption. The message transmitted via the chat room may be obtained based on the message key. For example, the message transmitted via the chat room may be obtained as a result of decrypting ciphertext of the message with the message key.

A chat room key may include a public key of the chat room and a private key of the chat room. The chat room key may be an asymmetric key. The public key of the chat room may refer to a public key to encrypt the message key. The private key of the chat room may refer to a private key to decrypt the encrypted message key (in other words, the ciphertext of the message key). In other words, the private key of the chat room may be a key of the chat room generated as a pair with the public key of the chat room. The private key of the chat room may be a decryption key of the message key encrypted with the public key of the chat room.

A user key may be an asymmetric key and may include a public key of the user and a private key of the user. The public key of the user may be a public key generated by a user terminal or the server 820 corresponding to an account of the user and may refer to a public key to encrypt data. The private key of the user may be a private key generated corresponding to the user account and may refer to a private key to decrypt the data encrypted with the public key of the user. The public key of the user may be stored in a database accessible by the other user terminal and/or the server 820. The private key of the user may be stored in the user terminal and/or when the private key is stored outside of the user terminal, the private key of the user may be stored as ciphertext of the encrypted private key.

The user terminal (e.g., the user terminal 110 of FIG. 1 or the host terminal 210 of FIG. 2) may obtain ciphertext of the message from the server 820 to obtain the message of the chat room. The user terminal may need a message key to decrypt the ciphertext of the message. The message key may be the ciphertext of the message key encrypted with the public key of the chat room and may be stored in the database. Accordingly, the user terminal may need the private key of the chat room to decrypt the ciphertext of the message key. As a result, the user terminal may need the private key of the chat room to obtain the message transmitted via the chat room.

Referring to FIG. 8, an example of an operation in which a host terminal 810 (e.g., the host terminal 210 of FIG. 2) delivers a private key of a chat room to a guest terminal 830 (e.g., the guest terminal 230 of FIG. 2) that joins the chat room via a position-based chat room entry function is described. As a symmetric key to encrypt or decrypt the private key of the chat room, the host terminal 810 may encrypt the private key of the chat room using a join code (or input code) and transmit the encrypted private key to the guest terminal 830.

In FIG. 8, Eₖ(l) may denote a result (e.g., ciphertext) obtained by encrypting plaintext l with a key k, and Dₖ(c) may denote a result obtained by decrypting ciphertext c with the key k.

In operation S801, the host terminal 810 may transmit a chat room generation request to the server 820. The host terminal 810 may request to generate a chat room to which the secured IMS is applied.

In operation S802, the host terminal 810 may generate a chat room key. Tₑ may denote a public key of the chat room, and T_{d} may denote a private key of the chat room.

In operation S803, the host terminal 810 may generate ciphertext of the private key of the chat room by encrypting the private key of the chat room with a public key of a host. H may denote the public key of the host.

In operation S804, the host terminal 810 may transmit the ciphertext obtained by encrypting the private key of the chat room with the public key of the host to the server 820. The server 820 may store, in the database, the ciphertext obtained by encrypting, with the public key of the host, the private key of the chat room received from the host terminal 810.

Operations S803 and S804 may be back-up operations to prevent loss of the stored private key of the chat room in the host terminal 810 and may be omitted.

In operation S805, the host terminal 810 may transmit an activation request to activate the position-based chat room entry function of the chat room to the server 820. The server 820 may receive the activation request to activate the position-based chat room entry function of the chat room from the host terminal 810.

In operation S806, the server 820 may generate a join code in response to the activation request and may transmit information about the generated join code to the host terminal 810. The host terminal 810 may receive the information about the join code from the server 820.

In operation S807, after receiving the information about the join code, the host terminal 810 may generate ciphertext of the private key of the chat room by encrypting the private key of the chat room with the join code. In FIG. 8, C may denote a join code, and E_{C}(T_{d}) may denote ciphertext of the private key of the chat room encrypted with the join code.

In operation S808, the host terminal 810 may transmit the ciphertext E_{C}(T_{d}) of the private key of the chat room to the server 820. The server 820 may receive the ciphertext E_{C}(T_{d}) of the private key of the chat room, obtained by encrypting the private key of the chat room with the join code, from the host terminal 810.

Although not explicitly illustrated in FIG. 8, the server 820 may receive information about an input code that is the same as the join code from the guest terminal 830 and may allow the guest account to join the chat room based on that the guest terminal 830 is positioned in the join area.

In operation S809, the guest terminal 830 may transmit a join request to join the chat room to the server 820. The server 820 may receive the join request to join the chat room.

In operation S810, the server 820 may allow the guest account to join the chat room and may transmit the ciphertext E_{C}(T_{d}) of the private key of the chat room to the guest terminal 830 based on receiving the join request to join the chat room from the guest terminal 830. After transmitting the join request, the guest terminal 830 may receive the ciphertext E_{C}(T_{d}) of the private key of the chat room from the server 820.

In operation S811, the guest terminal 830 may obtain a private key T_{d} of the chat room by decrypting the received ciphertext E_{C}(T_{d}) of the private key of the chat room with the input code. Since the input code obtained from the guest terminal 830 that is added to the participant of the chat room is the same as the join code C of the chat room, the ciphertext E_{C}(T_{d}) of the private key of the chat room encrypted with the join code C, which is the symmetric key, may be decrypted with the input code.

The guest terminal 830 may obtain a message key by decrypting the ciphertext of the message key with the obtained private key T_{d} of the chat room. The guest terminal 830 may obtain a transmitted or received message via the chat room based on the obtained message key.

According to an embodiment, the guest terminal 830 may receive, from the server 820, the ciphertext of the message transmitted via the chat room before the guest account joins the chat room. As a result, the guest terminal 830 may obtain the message transmitted via the chat room before the guest account joins the chat room.

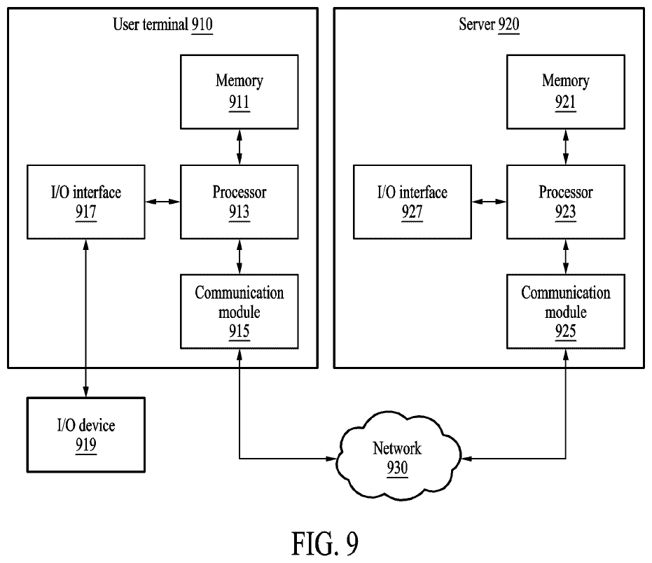

FIG. 9 illustrates an example of a hardware configuration of a system for an IMS according to an embodiment.

Referring to FIG. 9, a system (e.g., the instant messaging system 100 of FIG. 1) for an IMS according to an embodiment may include a user terminal 910 (e.g., the user terminal 110 of FIG. 1) connected via a network 930 (e.g., the network 130 of FIG. 1), and a server 920 (e.g., the server 120 of FIG. 1).

The user terminal 910 according to an embodiment may be a mobile terminal implemented as a computer device. For example, the user terminal 910 may communicate with the server 920 and/or other electronic devices (e.g., other user terminals or other servers) via the network 930 using a wireless communication scheme and/or a wired communication scheme.

The server 920 according to an embodiment may be implemented as a computer device or a plurality of computer devices providing an instruction, code, a file, content, or a service by communicating with the user terminal 910 and/or other servers via the network 930. The communication scheme is not limited and may include a communication scheme using a communication network (e.g., a mobile network, wired Internet, wireless Internet, or a broadcasting network) included in the network 930 and NFC among devices. For example, the network 930 may include at least one of a personal area network (PAN), a local area network (LAN), a campus area network (CAN), a metropolitan area network (MAN), a wide area network (WAN), a broadband network (BBN), and the Internet.

According to an embodiment, the server 920 may provide a file to install an app in the user terminal 910 connected via the network 930. In this case, the user terminal 910 may install an app (e.g., an app associated with an IMS) using the file provided by the server 920. In addition, the user terminal 910 may receive a service or content provided by the server 920 by connecting to the server 920 under the control of an operating system (OS) or at least one program (e.g., a browser or an installed app). For example, when the user terminal 910 transmits a request related to a service to the server 920 via the network 930 under the control of the app, the server 920 may transmit a code corresponding to the request to the user terminal 910, and the user terminal 910 may provide the content to the user by configuring and displaying a screen in response to the code according to the control of the app.

According to an embodiment, the user terminal 910 may include a memory 911, a processor 913, a communication module 915, and an input/output (I/O) interface 917. The server 920 may include a memory 921, a processor 923, a communication module 925, and an I/O interface 927.

The processors 913 and 923 according to an embodiment may perform at least one operation related to the IMS described above with reference to FIGS. 1 to 8. For example, the processor 913 may perform at least one operation of the user terminal 910 performed by an app or web related to the IMS described above with reference to FIGS. 1 to 8, and the processor 923 may perform at least one operation of the server 920 that provides the social media service described above with reference to FIGS. 1 to 8. The processors 913 and 923 may be configured to process an instruction of a computer program by performing basic arithmetic, logic, and I/O operations. The instruction may be provided to the processors 913 and 923 by the memories 911 and 921 or the communication modules 915 and 925.

The memories 911 and 921 may be computer-readable storage media and may be volatile or non-volatile memories. The memories 911 and 921 according to an embodiment may store information to run an app or web related to the IMS described above with reference to FIGS. 1 to 8.

The memory 911 according to an embodiment may include code for an app related to an IMS installed and run on the user terminal 910 by files provided by the server 920 via the network 930.

The memory 921 according to an embodiment may store a program in which operations for the IMS described above with reference to FIGS. 1 to 8 are implemented.

The communication modules 915 and 925 according to an embodiment may include communication circuitry. The communication modules 915 and 925 may provide a function for the user terminal 910 and the server 920 to communicate with each other via the network 930 and may provide a function to communicate with other electronic devices or other servers.

For example, a request generated by the processor 913 of the user terminal 910 according to program code related to an app associated with the IMS stored in a storage medium, such as the memory 911, may be transmitted to the server 920 via the network 930 under the control of the communication module 915.

For example, a control signal, an instruction, content, or a file provided under the control of the processor 923 of the server 920 may be transmitted to the user terminal 910 via the communication module 915 of the user terminal 910 via the communication module 925 and the network 930.

The I/O interfaces 917 and 927 may be a means for interfacing with an I/O device 919. For example, an input device may include a device, such as a keyboard or a mouse, and an output device may include a device, such as a display for displaying a communication session of an app. In another example, the I/O interface 917 may be a means for interfacing with a device in which input and output functions are integrated, such as a touchscreen. As a more specific example, to process an instruction of a computer program loaded to the memory 911, the processor 913 of the user terminal 910 may display a service screen or content configured using the data provided by the server 920 on a display via the I/O interface 917. For example, at least one interface screen described above with reference to FIGS. 1 to 8 may be displayed on the display via the I/O interface 917. An input received from a user via the I/O device 919 may be provided in a form that may be processed by the processor 913 of the user terminal 910 via the I/O interface 917.

According to an embodiment, the user terminal 910 and the server 920 may include other components that are not shown in FIG. 9. For example, the user terminal 910 may be implemented to include at least a portion of the I/O device 919 described above or may further include other components, such as a transceiver, a GPS module, a camera, a sensor, or a database.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor, or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

### Technical Effects

The disclosed embodiments recognize that managing chat room entry in mobile environments is fundamentally a network control and device coordination problem rather than a mere social interaction. The system therefore employs real-time positional data, activation timing, and encryption processes to coordinate device behavior and server authentication, thereby improving the technical performance of the communication platform.

By reframing chat room participation as a network control and device coordination problem, the disclosed method provides a technical mechanism for dynamically managing access to communication sessions. Through automated determination of a join area and transmission of encrypted access information, the system achieves improved computational efficiency and security in managing multi-user network connections.

Namely, the disclosed configuration (1) improves computing efficiency in authentication processes by combining geolocation-based verification with automatic credential issuance; (2) reduces network overhead by eliminating unnecessary host confirmation messaging; and (3) enhances data security by encrypting session credentials with a context-specific join code. These effects are rooted in the operation of the server and networked terminals and represent improvements to computer networking and communication technologies.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An instant messaging method performed by a server, the method comprising:
in response to an activation request to activate a position-based chat room entry function in a chat room received from a host terminal of the chat room, determining a join area based on a position of the host terminal;
in response to the activation request, generating a join code for the chat room and transmitting information about the generated join code to the host terminal;
activating the position-based chat room entry function of the chat room based on the join code and the join area;
receiving a join request with respect to the chat room from a guest terminal of a guest account;
determining whether the join request is generated via an access link to the chat room or via the position-based chat room entry function;
based on that the join request is generated via the access link to the chat room, determining whether to add the guest account to a participant of the chat room according to a response from the host terminal to the join request; and
based on that the join request is generated via the position-based chat room entry function, adding the guest account to a participant of the chat room independently of a response from the host terminal.

2. The method of claim 1, further comprising:
receiving, from the guest account, information about an input code input by a user;
from a plurality of candidate chat rooms with activated position-based chat room entry functions, determining the chat room having the join code that is the same as the input code;
based on that the guest terminal is positioned in a join area of the determined chat room, allowing the guest account to join the chat room and transmitting information about the determined chat room to the guest terminal; and
based on receiving a join request to join the chat room from the guest terminal, adding the guest account to a participant of the chat room.

3. The method of claim 1, wherein the determining of the join area comprises, based on that the host terminal of the chat room includes a first host terminal and a second host terminal, determining a second area determined based on a position of the second host terminal to be the join area together with a first area determined based on a position of the first host terminal.

4. The method of claim 1, wherein the determining of the join area comprises, based on receiving, from the host terminal, an addition request of a join area based on another user account that joins the chat room, adding an area determined based on a position of the other user account to the join area.

5. The method of claim 1, wherein the determining of the join area comprises, in response to a first activation request received from the host terminal, determining a first join area based on a first position of the host terminal at a first time point corresponding to the first activation request,
wherein the method further comprises:
based on at least one of a deactivation request to deactivate the position-based chat room entry function received from the host terminal or elapse of a predetermined time from the first time point, deactivating the position-based chat room entry function of the chat room based on the first activation request;
based on receiving a second activation request with respect to the chat room from the host terminal after deactivation, determining a second join area based on a second position of the host terminal at a second time point corresponding to the second activation request; and
activating the position-based chat room entry function of the chat room to allow a guest account of a guest terminal positioned in at least one of the first join area or the second join area to enter the chat room.

6. The method of claim 1, further comprising:
while an entry function to the chat room is activated, based on detecting a position change of the host terminal, changing the join area based on a changed position of the host terminal.

7. The method of claim 1, further comprising:
receiving ciphertext of a private key of the chat room from the host terminal, wherein the ciphertext is obtained by encrypting a private key of the chat room with the join code; and
based on allowing a guest account to join the chat room and receiving a join request to join the chat room from a guest terminal of the guest account, transmitting the ciphertext of the private key of the chat room to the guest terminal,
wherein the private key of the chat room is a key of the chat room generated as a pair with a public key of the chat room, and is a decryption key of a message key encrypted with the public key of the chat room, and
a message transmitted via the chat room is obtained based on the message key.

8. An instant messaging method performed by a host terminal of a host account of a chat room, the method comprising:
transmitting, to a server, an activation request to activate a position-based chat room entry function in the chat room based on a user input;
receiving information about a join code for the chat room from the server; and
based on that a guest account using a guest terminal joins the chat room via a join request, displaying a screen related to the chat room in which the guest account is added as a participant of the chat room,
wherein, when the join request is generated via an access link to the chat room, the guest account joins the chat room according to a response from the host terminal to the join request, and
when the join request is generated via the position-based chat room entry function, independently of a response from the host terminal, the guest account joins the chat room based on that the guest terminal obtains an input code that is the same as the join code and the guest terminal is positioned in a join area of the chat room determined based on a position of the host terminal.

9. The method of claim 8, wherein the host terminal includes a first host terminal, and
based on that the host terminal of the chat room includes the first host terminal and a second host terminal, the join area is determined to be a second area based on a position of the second host terminal together with a first area determined based on a position of the first host terminal.

10. The method of claim 8, further comprising:
transmitting an addition request of a join area based on another user account that joins the chat room to the server,
wherein the join area is changed by adding an area determined based on a position of a terminal of the other user account to the join area.

11. The method of claim 8, wherein the transmitting of the activation request to the server comprises transmitting a first activation request to the server at a first time point,
the join area includes a first join area determined based on a first position of the host terminal at the first time point,
the position-based chat room entry function based on the first activation request is deactivated based on at least one of transmitting a deactivation request to deactivate the position-based chat room entry function to the server or elapse of a predetermined time from the first time point,
the method further comprises transmitting a second activation request with respect to the chat room to the server at a second time point after deactivation, and
the position-based chat room entry function of the chat room based on the second activation request allows a guest account of a guest terminal positioned in at least one of the first join area or a second join area determined based on a second position of the host terminal at the second time point to enter the chat room.

12. The method of claim 8, further comprising:
after receiving the information about the join code, generating ciphertext of a private key of the chat room by encrypting the private key of the chat room with the join code; and
transmitting the ciphertext of the private key of the chat room to the server,
wherein the private key of the chat room is a key of the chat room generated as a pair with a public key of the chat room, and is a decryption key of a message key encrypted with the public key of the chat room, and
a message transmitted via the chat room is obtained based on the message key.

13. A non-transitory computer-readable storage medium storing instructions that, when executed by a processor, cause the processor to perform the method of claim 1.

14. A server comprising:
at least one processor including processing circuitry; and
memory including one or more storage media storing instructions,
wherein the instructions, when executed individually or collectively by the at least one processor, cause the server to:
in response to an activation request to activate a position-based chat room entry function in a chat room received from a host terminal of the chat room, determine a join area based on a position of the host terminal,
in response to the activation request, generate a join code for the chat room and transmit information about the generated join code to the host terminal,
activate the position-based chat room entry function of the chat room based on the join code and the join area,
receive a join request with respect to the chat room from a guest terminal of a guest account,
determine whether the join request is generated via an access link to the chat room or via the position-based chat room entry function,
based on that the join request is generated via the access link to the chat room, determine whether to add the guest account to a participant of the chat room according to a response from the host terminal to the join request, and
based on that the join request is generated via the position-based chat room entry function, add the guest account to a participant of the chat room independently of a response from the host terminal.

15. The server of claim 14, wherein the instructions, when executed individually or collectively by the at least one processor, cause the server to, based on that the host terminal of the chat room includes a first host terminal and a second host terminal, determine a second area determined based on a position of the second host terminal to be the join area together with a first area determined based on a position of the first host terminal.

16. The server of claim 14, wherein the instructions, when executed individually or collectively by the at least one processor, cause the server to, based on receiving, from the host terminal, an addition request of a join area based on another user account that joins the chat room, add an area determined based on a position of the other user account to the join area.

17. The server of claim 14, wherein the instructions, when executed individually or collectively by the at least one processor, cause the server to:
in response to a first activation request received from the host terminal, determine a first join area based on a first position of the host terminal at a first time point corresponding to the first activation request,
based on at least one of a deactivation request to deactivate the position-based chat room entry function received from the host terminal or elapse of a predetermined time from the first time point, deactivate the position-based chat room entry function of the chat room based on the first activation request,
based on receiving a second activation request with respect to the chat room from the host terminal after deactivation, determine a second join area based on a second position of the host terminal at a second time point corresponding to the second activation request, and
activate the position-based chat room entry function of the chat room to allow a guest account of a guest terminal positioned in at least one of the first join area or the second join area to enter the chat room.

18. The method of claim 1, further comprising detecting proximity of the guest terminal to the host terminal using a short-range communication signal, and allowing the guest account to join the chat room only when the received signal strength exceeds a selected threshold.

19. The method of claim 1, wherein activating the position-based chat room entry function reduces a number of confirmation messages transmitted between the host terminal and the server by automatically approving join requests verified through the join area and join code.

20. The server of claim 14, wherein the memory stores executable instructions to identify expired join codes and corresponding encrypted access information and to delete the expired join codes and the corresponding encrypted access information from storage.
